(19) United States
(12) Patent Application Publication
(10) Pub. No.: US 2016/0246273 A1
(43) Pub. Date: Aug. 25, 2016

(54) CONTROLLER

(71) Applicant: Azbil Corporation, Tokyo (JP)

(72) Inventor: Makoto TAKAHASHI, Tokyo (JP)

(73) Assignee: Azbil Corporation, Tokyo (JP)

(21) Appl. No.: 15/050,632

(22) Filed: Feb. 23, 2016

(30) Foreign Application Priority Data
Feb. 23, 2015 (JP) 2015-032559

(51) Int. Cl. G05B 19/042

(52) U.S. Cl. CPC G05B 19/0423; G05B 2219/31121

(57) ABSTRACT

To enable setting data to be set in a replacing controller while further reducing the load on replacement work a controller connection portion is connected to a controller connection portion via a predetermined cable to make connection between a controller and a controller. An inputting portion is operated in this state to put a setting data sending portion in the operating state and then the inputting portion is operated to put a setting data receiving portion in the operating state. This operation causes the setting data sending portion to output the setting data stored in a setting data storing portion to the controller connected to the controller connection portion. On the other hand, the setting data receiving portion receives the setting data from the controller connected to the controller connection portion and stores the setting data in the setting data storing portion.

### CROSS-REFERENCE TO RELATED APPLICATION

The present application claims the benefit of and priority to Japanese Patent Application No. 2015-032559, filed on Feb. 23, 2015, the entire contents of which are incorporated by reference herein.

### TECHNICAL FIELD

The present invention relates to a controller used in a controlling system.

### BACKGROUND ART

A controlling system is used to monitor and control, for example, ancillary facilities of buildings and to control plants. In addition, an instrument controlling device may be also used for this purpose (see PTL 1). The controlling system conducts controlling by exchanging signals with field devices such as process devices and various types of sensors installed in a field connected via a network such as a field bus. In addition, the instrument controlling device exchanges signals with field devices such as process devices and various types of sensors installed in the field, makes operation settings previously performed by connecting mobile terminals to the field devices in the field using parameter settings from a higher level, and displays the diagnostic results of the normal operation state of the field devices.

Since many field devices are to be controlled, the controlling system performs division into blocks, provides a controller in each of the blocks, and performs distributed control using the controllers.

For example, as illustrated in FIG. 2, controllers 202 provided for the individual blocks are connected to a controlling device 201, an I/O module 203 is connected to each of the controllers 202, and a plurality of field devices 204 are connected to each of the I/O modules 203. A plurality of controllers 202 are connected to the controlling device 201 via a network 211 and the plurality of field devices 204 are connected to each of the I/O modules 203 via a signal line 212.

Each of the I/O modules 203 is provided with I/O data points to which inputs from the field devices 204 such as sensors or opening outputs from the field devices 204 such as valve positioners are individually connected.

In the distributed control as described above, there are parameters to be set for each block. These parameters to be set in the controllers, called setting data, include parameters for controlling the controller and other parameters. The setting data are manually set in the controller.

For example, a system of FOUNDATION fieldbuses by Fieldbus Foundation uses function blocks, which include “resource blocks” configured by parameters concerning field devices, “transducer blocks” having parameters concerning sensors, operation terminals, and hardware included in field devices, “function blocks” for achieving input-output functions or calculation functions for PIDs, and so on.

When a controller is replaced in the case of a failure or maintenance such as periodical replacement or periodical inspection in such a controlling system, the setting data before the replacement needs to be recorded and then be set for a replacing controller. The first method for recording the setting data is to write it on paper. The second method is to save the setting data as electronic data using software such as a word processor or spreadsheet. The third method is to read the setting values using a controller setting device and save it as electronic data (see PTL 2).

### CITATION LIST

### Patent Literature

[PTL 1] JP-A-2012-014388

[PTl 2] JP-A-2006-134098

### SUMMARY OF INVENTION

### Problem to be Solved by the Invention

However, the above data setting methods requires means for temporarily storing setting data separately in the field in which the controller to be replaced is installed, and the time and effort for setting the setting data again after temporarily storing it, thereby workload of replacement work increases.

The invention addresses the above problems with an object of enabling the setting data to be set for the replacing controller while further reducing the load on replacement work.

### Means for Solving the Problem

According to the invention, there is provided a controller performing control operation that outputs corresponding control data to a field device to be controlled, the controller including a setting data storing portion storing setting data for generating the control data, a control processing portion generating the control data based on the setting data stored in the setting data storing portion, an I/O controlling portion sending the control data generated by the control processing portion to the field device, a controller connection portion through which the controller is connected to another controller, a setting data sending portion outputting the setting data stored in the setting data storing portion to the other controller connected to the controller connection portion, and a setting data receiving portion receiving the setting data from the other controller connected to the controller connection portion and storing the setting data in the setting data storing portion.

### Advantageous Effects of Invention

As described above, according to the invention, it is possible to obtain the beneficial effect of setting the setting data for the replacing controller while further reducing the load on replacement work.

### BRIEF DESCRIPTION OF THE DRAWINGS

FIG. 1 is a structural diagram illustrating a part of the structure of a controlling system using a controller 100 according to an embodiment of the invention.

FIG. 2 is a structural diagram illustrating the structure of a controlling system in which division into blocks is made to control each block.

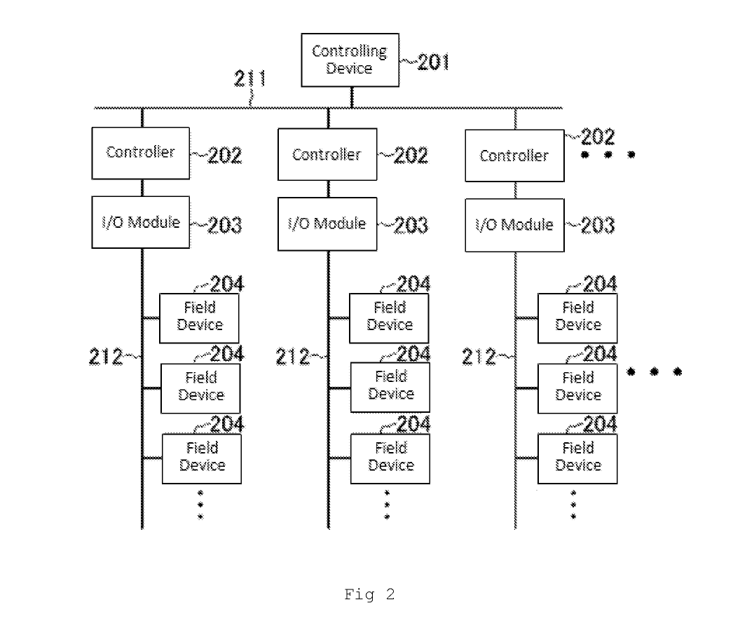

### MODE FOR CARRYING OUT THE INVENTION

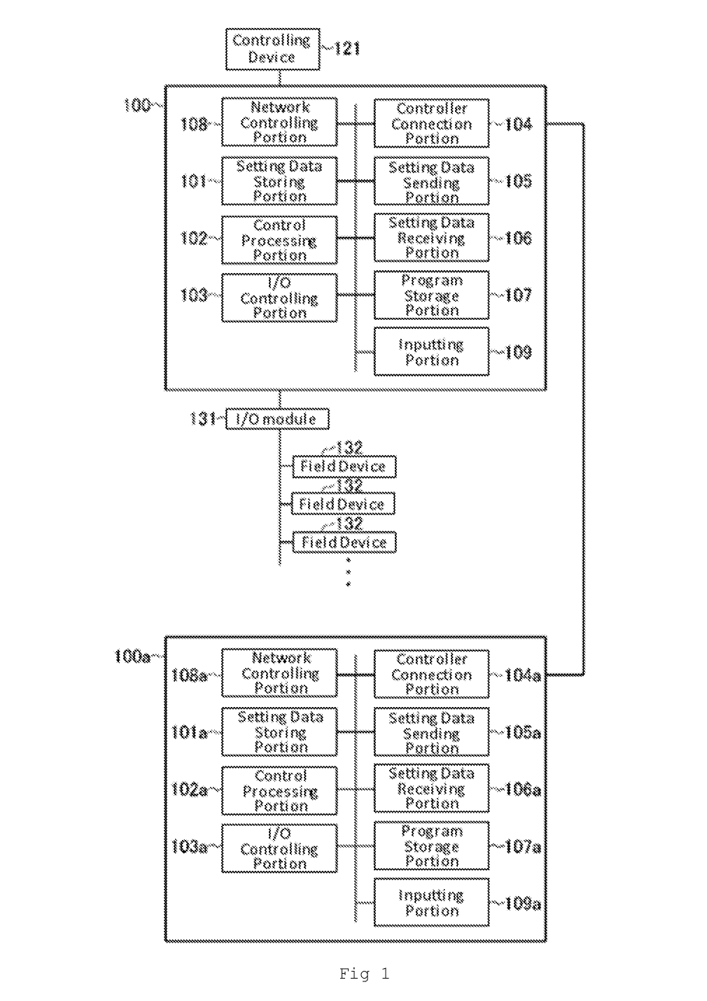

An embodiment of the invention will be described with reference to the drawings. FIG. 1 is a structural diagram illustrating a part of the structure of a controlling system including a controller 100 according to an embodiment of the invention. This system includes the controller 100, a controlling device 121, an I/O module 131, and field devices 132.

In the controlling device 121, the controller 100 is connected to each of the blocks. In addition, the I/O module 131 is connected to the controller 100 and a plurality of field devices 132 are connected to the I/O module 131. For example, the I/O module 131 is provided with I/O data ports (not illustrated) to which inputs from the field devices 132 such as sensors or opening outputs from the field devices 132 such as valve positioners are individually connected. Although a plurality of controllers are connected to the controlling device 121 via a network, FIG. 1 illustrates the state in which the controller 100 is connected to the controlling device 121 and other controllers are not illustrated.

The controller 100 includes a setting data storing portion 101, a control processing portion 102, an I/O controlling portion 103, a controller connection portion 104, a setting data sending portion 105, a setting data receiving portion 106, a program storage portion 107, a network controlling portion 108, and an inputting portion 109.

The setting data storing portion 101 stores setting data used to generate control data for controlling the field devices 132. The control processing portion 102 generates control data based on the setting data stored in the setting data storing portion 101. The I/O controlling portion 103 sends the control data generated by the control processing portion 102 to the field devices 132.

The controller connection portion 104 connects the controller 100 to another controller. The setting data sending portion 105 outputs the setting data stored in the setting data storing portion 101 to the other controller connected to the controller connection portion 104. The setting data receiving portion 106 receives the setting data from the other controller connected to the controller connection portion 104 and stores it in the setting data storing portion 101.

The program storage portion 107 stores a program for operating the control processing portion 102. The network controlling portion 108 establishes a network connection with the controlling device 121. The inputting portion 109 receives instruction inputs concerning the operation of the setting data sending portion 105 and the operation of the setting data receiving portion 106.

The replacement of the controller 100 that is built into the controlling system and connected to the controlling device 121 and the I/O module 131 with another controller (controller 100a) will be described below as an example. The controller 100a includes a setting data storing portion 101a, a control processing portion 102a, an I/O controlling portion 103a, a controller connection portion 104a, a setting data sending portion 105a, a setting data receiving portion 106a, a program storage portion 107a, a network controlling portion 108a, and an inputting portion 109a. This structure is similar to that of the controller 100.

First, the controller connection portion 104 is connected to the controller connection portion 104a via a predetermined cable to make connection between the controller 100 and the controller 100a. The inputting portion 109 is operated in this state to put the setting data sending portion 105 in the operating state and then the inputting portion 109a is operated to put the setting data receiving portion 106a in the operating state.

In the controller 100, the above operation causes the setting data sending portion 105 to output the setting data stored in the setting data storing portion 101 to the controller 100a connected to the controller connection portion 104. On the other hand, in the controller 100a, the setting data receiving portion 106a receives the setting data from the controller 100 connected to the controller connection portion 104a and stores it in the setting data storing portion 101a.

When the setting data stored in the setting data storing portion 101 is stored in the setting data storing portion 101a in this way, the controller 100 is stopped and the controller 100a is connected to the controlling device 121 and the I/O module 131 and built into the controlling system. Accordingly, in the controller 100a having started operating, the control processing portion 102a generates control data based on the setting data stored in the setting data storing portion 101a and the I/O controlling portion 103a sends the control data generated by the control processing portion 102a to the field devices 132. The setting data stored in the setting data storing portion 101a is the data previously stored in the setting data storing portion 101 and the control by the controller 100a is similar to that performed by the controller 100.

Here, the connection between the controller 100 (the controller connection portion 104) and the controller 100a (the controller connection portion 104a) only needs to be made by, for example, the USB (Universal Serial Bus). The connection via the USB enables power to be supplied to the controller 100a.

If the controller connection portion 104 is connected to another controller when detecting establishment of a network by the network controlling portion 108 and a connection with the I/O module 131 by the I/O controlling portion 103, the setting data sending portion 105 may operate. If the controller connection portion 104 is connected to another controller when not detecting establishment of a network by the network controlling portion 108 and a connection with the I/O module 131 by the I/O controlling portion 103, the setting data receiving portion 106 may operate.

The connection between the controller 100 (the controller connection portion 104) and the controller 100a (controller connection portion 104a) may be performed via the PoE (Power over Ethernet (registered trademark)). This connection also supplies power to the controller 100a.

In addition, the controller 100 (the controller 100a) may have a storing portion for storing model information, check the model of another controller to be connected based on the model information stored in the storing portion, and restrict the operation of the setting data sending portion 105 of own controller and the setting data receiving portion 106 of another controller when the model of another controller is different from its own. This prevents the setting data from being written when the model of the device is different, thereby preventing a replacement error.

In addition, both the controller 100 and the controller 100a may be connected to the controlling device 121 and the I/O module 131 so that the controller 100 stops operating automatically when the setting data sending portion 105 has output the setting data and the controller 100a starts operating when the setting data receiving portion 106a has stored the setting data in the setting data storing portion 101. This eliminates the need to turn on the power again.

The following operation is also allowed. First, in the state in which the controlling system to which the controller 100 is connected is operating, the controller 100a is also connected to the controlling system. In this state, the controller 100 causes the setting data sending portion 105 to operate and enter a mode for writing setting data and the controller 100 sets its own address to an unused communication address in the network of the controlling system.

On the other hand, the controller 100a causes the setting data receiving portion 106a to operate and enter a mode for receiving setting data and the controller 100a sets its own address to an unused communication address in the network of the controlling system. In this state, data transfer is performed. Upon completion of data transfer, the controller 100 stops operating and the controller 100a sets its own address to the communication address used by the controller 100 before the data transfer and starts operating using the new setting data. After that, if the controller 100 is removed, the controlling system is put in the operable state.

As described above, since setting data can be transmitted and received between controllers in the invention, the setting data can be set in the replacing controller while further reducing the load on replacement work.

The invention is not limited to the above embodiment and it is appreciated that those skilled in the art may perform many modifications and combinations within the technical concept of the invention.

### DESCRIPTION OF REFERENCE NUMERALS AND SIGNS

100, 100a: controller, 101, 101a: setting data storing portion, 102, 102a: control processing portion, 103, 103a: I/O controlling portion, 104, 104a: controller connection portion, 105, 105a: setting data sending portion, 106, 106a: setting data receiving portion, 107, 107a: program storage portion, 108, 108a: network controlling portion, 109, 109a: inputting portion, 121: controlling device, 131: I/O module, 132: field device.

1. A controller configured to perform control operations and output control data to a field device, the controller comprising:
a setting data storing portion configured to store setting data;
a control processing portion in electronic communication with the setting data storing portion and configured to generate control data based on setting data stored in the setting data storing portion;
an I/O controlling portion in electronic communication with the control processing portion and configured to send control data generated by the control processing portion to the field device,
a controller connection portion in electronic communication with the I/O controlling portion and through which the controller is electronically connected to another controller;
a setting data sending portion in electronic communication with the controller connection portion and configured to output setting data stored in the setting data storing portion to the another controller connected to the controller connection portion; and
a setting data receiving portion in electronic communication with the controller connection portion and configured to receive setting data from the another controller connected to the controller connection portion, the setting data receiving portion configured to store setting data in the setting data storing portion.

2. The controller of claim 1, further comprising a program storage portion in electronic communication with the controller processing portion, the program storage portion configured to store a program for operating the controller processing portion.

3. The controller of claim 1, further comprising a network controlling portion configured to establish an electronic network connection with a controlling device.

4. The controller of claim 1, further comprising an inputting portion in electronic communication with the setting data sending portion and the setting data receiving portion, the inputting portion configured to receive instruction inputs concerning the setting data sending portion and the setting data receiving portion.

5. The controller of claim 1, wherein the controller is electronically connected to the another controller through the controller connection portion via an electronic cable.

6. The controller of claim 1, wherein the controller is electronically connected to the another controller through the controller connection portion via a Universal Serial Bus.

7. The controller of claim 1, wherein the I/O controlling portion comprises one or more data ports to which an input to the field device or an output from the field device is electronically connected.

8. The controller of claim 1, wherein the field device is a sensor or a valve positioner.

9. The controller of claim 1, wherein the controller is configured such that, when setting data stored in the setting data storing portion is sent to and stored in a setting data storing portion of the another controller, operation of the controller is stopped.

10. The controller of claim 1, further comprising a model storing portion electronically connected with the controller connection portion, the setting data sending portion, and the sending data receiving portion, the model storing portion configured to store data relating to compatible controller models.

11. The controller of claim 10, wherein the model storing portion is configured to restrict operation of at least one of the setting data sending portion and the sending data receiving portion when the model of the another controller is different from a model stored in the model storing portion.

12. A method of replacing a controller in a controlling system, comprising:
electronically connecting a controlling device along an electronic network, the controller comprising:
a setting data storing portion configured to store setting data that is output to a field device;
a control processing portion in electronic communication with the setting data storing portion and configured to generate control data based on setting data stored in the setting data storing portion;
an I/O controlling portion in electronic communication with the control processing portion and configured to send control data generated by the control processing portion to the field device,
a controller connection portion in electronic communication with the I/O controlling portion;
a setting data sending portion in electronic communication with the controller connection portion;
a setting data receiving portion in electronic communication with the controller connection portion;
electronically connecting another controller to the controller connection portion of the controller, wherein electronic connection of the another controller causes the setting data sending portion of the controller to send setting data to a setting data receiving portion of the another controller; and
disconnecting the controller from the controlling system.

13. The method of claim 12, wherein the step of electronically connecting another controller to the controller connection portion occurs through an electronic cable.

14. The method of claim 12, wherein the step of electronically connecting another controller to the controller connection portion occurs over the electronic network.

15. The method of claim 12, wherein when setting data is received in the setting data receiving portion of the another controller, operation of the controller is stopped.

16. The method of claim 12, wherein when setting data is received in the setting data receiving portion of the another controller, operation of the another controller is started.

17. The method of claim 12, wherein when setting data is received in the setting data receiving portion of the another controller, the another controller sets its address on the electronic network to an address immediately previously used by the controller.

18. A controlling system, comprising:
a controlling device;
a plurality of controllers electronically connected to the controlling device across a data network, each controller configured to perform control operations and output control data to a field device, each controller comprising:
a setting data storing portion configured to store setting data;
a control processing portion in electronic communication with the setting data storing portion and configured to generate control data based on setting data stored in the setting data storing portion;
an I/O controlling portion in electronic communication with the control processing portion and configured to send control data generated by the control processing portion to a field device,
a controller connection portion in electronic communication with the I/O controlling portion and through which the controller is electronically connected to another controller;
a setting data sending portion in electronic communication with the controller connection portion and configured to output setting data stored in the setting data storing portion to the another controller connected to the controller connection portion; and
a setting data receiving portion in electronic communication with the controller connection portion and configured to receive setting data from another controller connected to the controller connection portion, the setting data receiving portion configured to store setting data received from the another controller in the setting data storing portion.
